(19) United States
(12) Patent Application Publication
(10) Pub. No.: US 2007/0153012 A1
(43) Pub. Date: Jul. 5, 2007

(54) Image processing apparatus and image processing system

(75) Inventors: Masahiro Kamiya, Toyohashi-shi (JP); Shigeki Nozawa, Hoi-gun (JP); Yoshiki Nakazawa, Toyokawa-shi (JP); Kunio Furukawa, Toyokawa-shi (JP); Masazumi Ito, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/515,782

(22) Filed: Sep. 6, 2006

(30) Foreign Application Priority Data
Jan. 3, 2006 (JP) 2006-000003

(51) Int. Cl. G09G 5/39

(52) U.S. Cl. 345/531

(57) ABSTRACT

An image processing apparatus and an image processing system are capable of efficiently carrying out processing using a smaller memory. When a control program is downloaded via a network from an external apparatus such as a PC and stored in a volatile memory, a job analyzing unit analyzes the content of an issued job and determines which modules of the control program are necessary and which modules are unnecessary based on the state of an MFP detected by an energy saving mode control unit and/or an inoperative state detecting unit. Unnecessary modules are deleted from the volatile memory.

### CROSS REFERENCE TO RELATED APPLICATION

This application is based on the Japanese Patent Application No. 2006-000003 filed on Jan. 3, 2006, the content of which is hereby incorporated by reference.

### BACKGROUND OF THE INVENTION

1. Field of the Invention

The present invention relates to an image processing apparatus and an image processing system, and in particular to an image processing apparatus and an image processing system where a control program is acquired from outside and stored in a volatile storage means inside the image processing apparatus.

2. Description of Related Art

The operation of a modern image processing apparatus such as an image forming apparatus is controlled by having a control program sometimes referred to as “firmware” run on a processor, such as a CPU. The control program used to be stored in a mask ROM installed in the image processing apparatus before shipping, but since a complex process is required to replace the mask ROM when updating the control program, it has become increasingly common to store the control program in a rewritable nonvolatile memory, such as a flash ROM.

However, due to the improved functioning of image processing apparatuses in recent years, such control programs have become large. Storing all of such large firmware in a flash ROM causes an increase in cost, and therefore Japanese Laid-Open Patent Publication No. 2001-67228 discloses a technique where only the necessary modules for a print process are downloaded from an external apparatus such as a personal computer (PC).

### SUMMARY OF THE INVENTION

When only the necessary modules for executing a print job are downloaded as in the reference mentioned above, there is the problem that more time is taken from the issuing of the job to the start of execution of the job. To start the execution of the job sooner, it is necessary to keep more control program modules inside the image processing apparatus, but this leads to an increase in the necessary memory space and in turn to increased cost.

The present invention was conceived in view of the problem described above and it is an object of the present invention to provide an image processing apparatus and an image processing system that are capable of efficiently carrying out processing using a smaller memory.

To solve the problem described above, an image processing apparatus according to the present invention includes: a control program acquiring unit that acquires a control program for controlling the image processing apparatus in module units from outside the image processing apparatus; a volatile memory device that stores at least one of the modules acquired by the control program acquiring unit; a module deletion determining unit that determines which modules out of the at least one modules stored by the volatile memory device are deletable; and a deletion controller that deletes the modules determined to be deletable by the module deletion determining unit from the volatile memory device.

With the image processing apparatus according to the present invention, modules of a control program acquired from outside are stored in a volatile memory device and since deletable modules of the control program are determined and deleted from the volatile memory device, processing can be carried out efficiently using a smaller memory. Note that the expression “control program” refers to a program for controlling an appliance.

A construction may be used where a region in the volatile memory device aside from a part that stores the control program is used as a region that stores data of an image subjected to processing. As data of an image subjected to processing, it is possible to store image data converted by a RIP (Raster Image Processing) process, for example. The method of using the region aside from the part that stores the control program (i.e., the empty region) is not limited to such however.

An image processing system according to the present invention includes: an image processing apparatus; and a control program providing apparatus that includes a storage device and is connected to the image processing apparatus, the image processing apparatus including: a control program acquiring unit that acquires a control program for controlling the image processing apparatus in module units from the control program providing apparatus; a volatile memory device that stores at least one of the modules acquired by the control program acquiring unit; a module deletion determining unit that determines which modules out of the at least one modules stored by the volatile memory device are deletable; and a deletion controller that deletes the modules determined to be deletable by the module deletion determining unit from the volatile memory device.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a diagram showing one example of the overall construction of an image processing system;

FIG. 2 is a block diagram showing one example of the construction of an MFP 100;

FIG. 3 is a diagram showing one example of the content of a control program module management table;

FIG. 4 is a diagram useful in explaining one example of when control program modules are downloaded into a volatile memory 140 from a PC 31A as one example of an external apparatus;

FIG. 5 is a flowchart showing one example of the procedure when the power of the MFP 100 is turned on;

FIG. 6 is a flowchart showing an example of the procedure of the content checking process;

FIG. 7 is a flowchart for explaining one example of the procedure when a job is issued to the MFP 100;

FIG. 8 is a flowchart for explaining one example of the procedure when carrying out a module deleting process;

FIG. 9 is a flowchart showing one example of the procedure of a sheet-feeding control module deleting process;

FIG. 10 is a flowchart showing one example of the procedure of an option sheet-feeding control module deleting process;

FIG. 11 is a flowchart showing one example of the procedure of a delivery control module deleting process;

FIG. 12 is a flowchart showing one example of the procedure of the two-sided conveying control module deleting process;

FIG. 13 is a flowchart showing one example of the procedure of a USB appliance-related control module deleting process;

FIG. 14 is a flowchart showing one example of the procedure of a communication control module deleting process;

FIG. 15 is a flowchart showing one example of the procedure of an image stabilizing control module deleting process;

FIG. 16 is a flowchart useful in explaining one example of the procedure of a module rearranging process; and

FIG. 17 is a diagram useful in explaining the fragmentation of modules and a module rearranging process.

### DETAILED DESCRIPTION OF THE PREFERRED EMBODIMENT

An embodiment of the present invention will now be described with reference to the attached drawings with an MFP (MultiFunction Peripheral) as one example of an image processing apparatus according to the present invention. Note that an MFP is an image forming apparatus where functions such as “copy”, “network print”, “scan”, “fax”, and “document server” are collectively provided. Such devices are also called “multifunction devices”.

(1) Construction of an Image Processing System

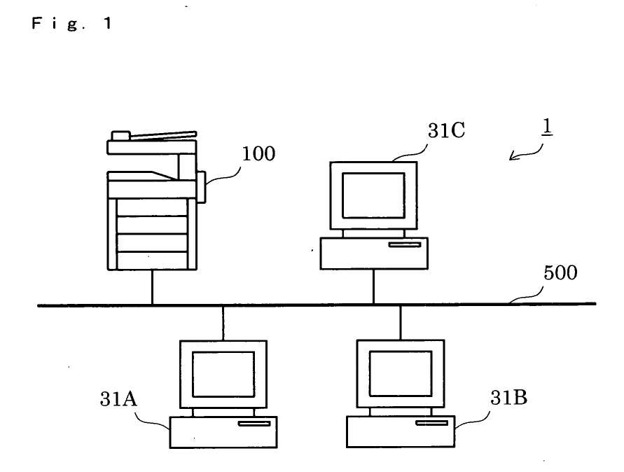

FIG. 1 is a diagram showing one example of the overall construction of an image processing system. The image processing system 1 is constructed by connecting an MFP 100 according to the present embodiment and personal computers (PCs) 31A, 31B, and 31C via a network 500, such as a LAN. Any number of PCs may be connected, and although three PCs are connected in FIG. 1, only one PC may be present. In the same way, any number of image processing apparatuses such as MFPs may be connected. As examples, TCP/IP, FTP, the wired LAN standard IEEE 802.3, the wireless LAN standard IEEE 802.11, and the like may be used as the communication protocol or standard on the network 500.

A print instructing program that instructs the MFP 100 to print documents and the like generated by software such as a word processor application installed in the PC31x (hereinafter, the expression. “PC 31x” is used to represent the PCs 31A, 31B, and 31C) is installed in the PC 31x. In the present embodiment, a control program for the MFP 100 is also stored in a storage means such as a hard disk (not shown) provided in the PC 31x. The control program is stored in module units, and it is possible to receive download requests from the MFP 100 and to download the control program from the PC31x in module units. Note that in place of the PC 31x, a workstation, a mobile information terminal or the like may be used.

(2) Construction of the MFP 100

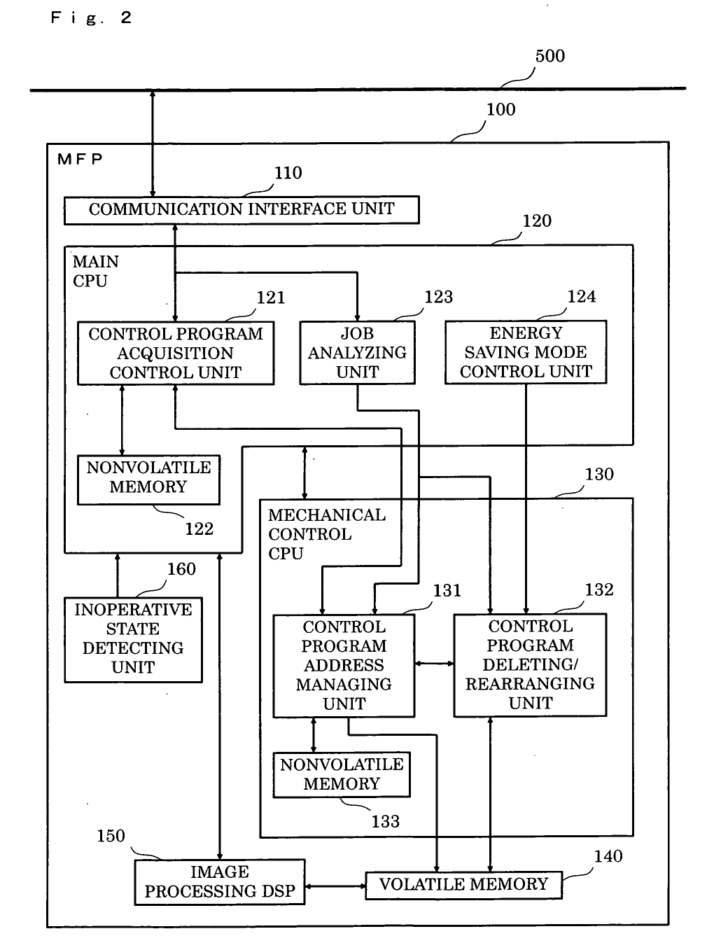

FIG. 2 is a block diagram showing one example of the construction of the MFP 100 according to the present embodiment. The MFP 100 includes a communication interface unit 110, a main CPU 120, a mechanical control CPU 130, a volatile memory 140, an image processing DSP (digital signal processor) 150, and an inoperative state detecting unit 160.

The communication interface unit 110 exchanges data with an external apparatus such as the PC 31x. As one example, a NIC (Network Interface Card) can be used as the communication interface unit 110. The main CPU 120 includes a control program acquisition control unit 121, a nonvolatile memory 122, a job analyzing unit 123, and an energy saving mode control unit 124.

The control program acquisition control unit 121 downloads the control program in module units from an external apparatus such as the PC 31x via the communication interface unit 110. In the present embodiment, out of the downloaded modules, modules that run on the mechanical control CPU 130 are stored in the volatile memory 140. An SRAM (synchronous RAM) capable of high-speed access is used as the volatile memory 140. Note that in addition to the control program modules that run on the mechanical control CPU 130, the volatile memory 140 is used to store image data that has been converted by the image processing DSP 150.

In the present embodiment, the necessary control program modules are downloaded from an external apparatus such as the PC31x as appropriate, such as when the power of the MFP 100 is turned on. Note that a program that carries out the minimum required processing when the MFP 100 is turned on is stored in the nonvolatile memory 122 inside the main CPU 120. A rewritable memory such as a flash ROM is favorably used as the nonvolatile memory 122. It should be obvious that a construction where a control program that runs on the main CPU 120 is also downloaded from the PC 31× and stored in a program memory, not shown, may be used, but detailed description of the control program that runs on the main CPU 120 is omitted here.

Although parts provided in a typical MFP such as operation buttons, a display panel, a scanner, an image forming unit, a document feeder, and a sheet feeding device have been omitted from FIG. 2, the main CPU 120 and the mechanical control CPU 130 are connected to such parts and can acquire information showing the states of such parts as appropriate from sensors or the like provided at such parts. The mechanical control CPU 130 is provided separately to the main CPU 120 as a processor for controlling parts that operate mechanically, such as a scanner, image forming unit, document feeder, and sheet feeding device. Aside from the control program modules downloaded from the external apparatus, appropriate information is exchanged between the main CPU 120 and the mechanical control CPU 130. Note that it is also possible to change the assignment of functions to be executed by the respective CPUs.

When any of a variety of jobs, such as copy, print, scan, and FAX transmission jobs, is issued from an external apparatus such as the PC 31x or from the operation panel or the like, the job analyzing unit 123 analyzes the content of the issued job, determines the necessary control program modules, and informs the mechanical control CPU 130. The energy saving mode control unit 124 carries out control to switch to an energy saving mode (a so-called “sleep mode”).

A control program address managing unit 131 stores the control program modules downloaded from the external apparatus, such as the PC 31x, in the volatile memory 140 and also manages addresses in the memory for the control program modules stored in the volatile memory 140. On being informed of the necessary control program modules from the job analyzing unit 123, the control program address managing unit 131 determines whether the required control modules are stored in the volatile memory 140. When such modules are not stored, the job analyzing unit 123 sends an instruction to the control program acquisition control unit 121 to download the necessary control modules from an external apparatus.

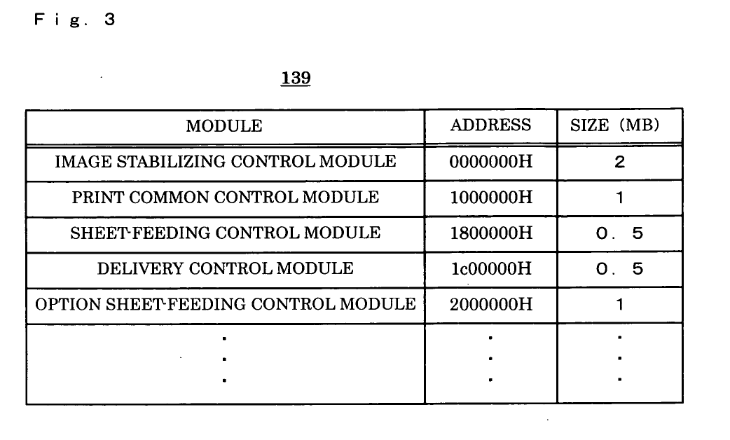

The control program address managing unit 131 manages, in table format for example, the addresses of the storage positions and program sizes of the programs stored in the volatile memory 140. FIG. 3 is a diagram showing one example of the content of the control program module management table. A control program module management table 139 is stored in a nonvolatile memory 133 connected to the mechanical control CPU 130, for example. As shown in FIG. 3, data showing the modules of the control program, the initial addresses inside the volatile memory 140 at which the respective modules are stored, and sizes of the modules are stored in the control program module management table.

By referring to the management table, the mechanical control CPU 130 can grasp the internal state of the volatile memory 140, such as whether the modules necessary for executing a job are stored in the volatile memory 140, the size of the region storing the control program inside the volatile memory 140, and whether or not the region storing the control program is fragmented. Note that “fragmentation” in the present embodiment refers to a state where empty regions are present between the regions storing the respective modules. It is possible to determine whether fragmentation has occurred by referring to the management table and determining that fragmentation has occurred when the size of a region in which no module is stored between the end of a region in which a module is stored and the start of the next region in which a module is stored exceeds a predetermined value set in advance.

A control program deleting/rearranging unit 132 deletes control program modules stored in the volatile memory 140 and rearranges the modules when fragmentation has occurred according to information from the job analyzing unit 123 relating to the control program modules necessary for executing a job, the states of appliances (such as whether a sheet-feeding cassette is empty or whether a sheet-feeding cassette has not been attached) as notified from the main CPU 120, and other information. By deleting and rearranging the control program modules, jobs can be efficiently executed while suppressing the size of the volatile memory 140.

(3) Downloading and Storage of Control Program Modules in the Volatile Memory 140

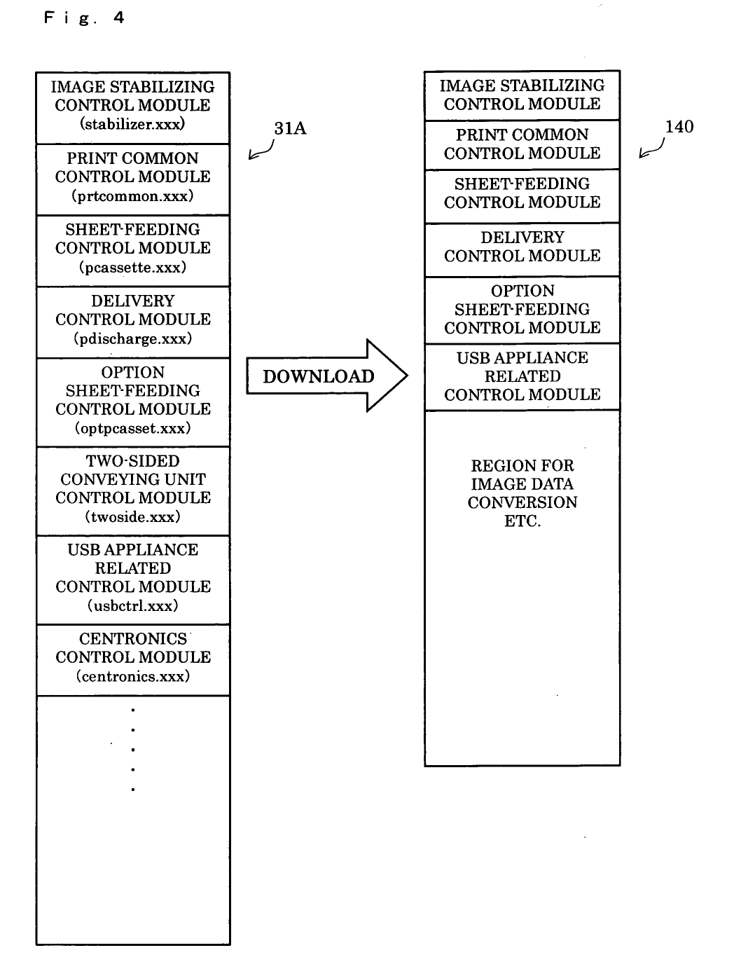

Storage of the control program modules in the volatile memory 140 will now be described. FIG. 4 is a diagram useful in explaining an example state of a volatile memory 140 when downloading control program modules into the volatile memory 140 from the PC 31A as one example of an external apparatus.

An operating system such as WINDOWS (registered trademark) is normally installed on the external apparatus such as the PC 31x and the control program modules are managed as separate files for each module. In the example in FIG. 4, as one example, an image stabilizing control module is stored in a storage means such as a hard disk or the like as a file with the file name (stabilizer.xxx) at the PC 31A.

In the MFP 100 also, the file name of each module is managed, and when the control program acquisition control unit 121 sends a download request for a control program module to the external apparatus such as the PC 31x, the control program acquisition control unit 121 designates the file name of the necessary module and downloads the module in accordance with a protocol for transferring files, such as FTP (File Transfer Protocol). Next, with the mechanical control CPU 130 of the present embodiment, when the downloaded module is stored in the volatile memory 140, the initial address and size are written in the management table described above. Although it is conceivably possible to not keep the file names when modules are stored in the volatile memory 140, the file names of the downloaded modules may be stored in the management table along with the download time/date and an identifier of the source of the download (a computer name or the like).

A part of the volatile memory 140 in which the control program modules are not stored is used as a region that stores image data converted by the image processing DSP 150 (hereinafter referred to as the “image data utilized region”). The necessary capacity of the image data utilized region differs according to the functions of the MFP 100 and the issued job. The control program deleting/rearranging unit 132 enables the volatile memory 140 to be used more efficiently by deleting modules that are not needed from the volatile memory 140 and rearranging the modules.

(4) Processing by the MFP 100

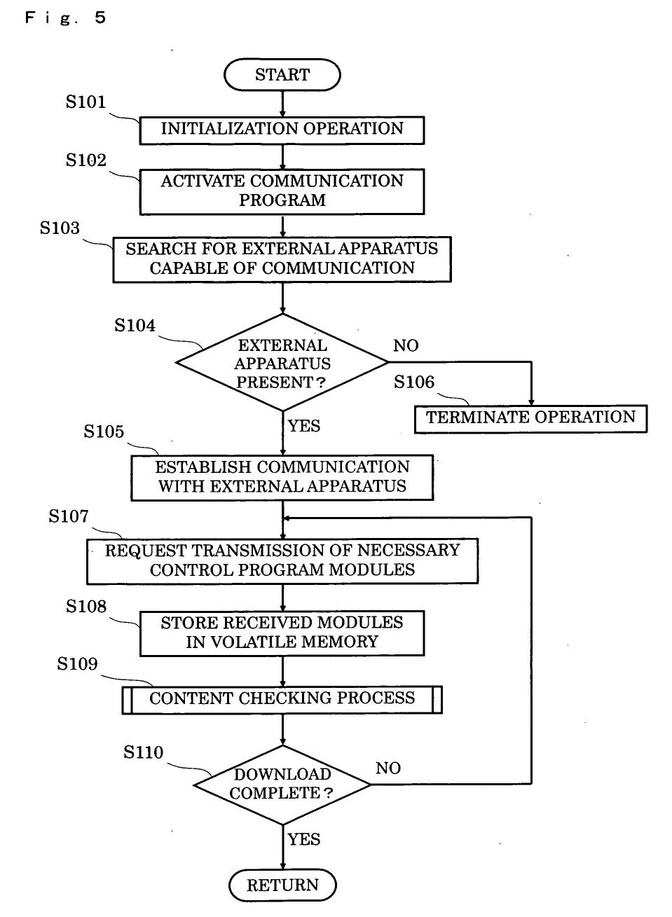

The processing carried out by the MFP 100 when downloading control program modules will now be described with reference to a flowchart. FIG. 5 is a flowchart showing one example of the processing content when the power of the MFP 100 is turned on.

When the power of the MFP 100 is turned on (or the MFP 100 is reset), first an initialization operation is carried out (S101) and a communication program is activated (S102). The initialization operation includes an image stabilizing operation, a warming up process for a fixing device, and the like. The communication program activated here is the minimum program required for communication (including the downloading of the control program) with an external apparatus such as the PC31x based on TCP/IP or SMB, for example, and is stored in the nonvolatile memory 122 of the main CPU 120.

Next, the activated communication program searches for external apparatuses with which the MFP 100 can communicate (S103). As one example, this search can be carried out by transmitting a broadcast packet with a content that requests downloading of control program modules of the MFP 100 on the network 500. When a response indicating compliance for the request is received from an external apparatus such as the PC 31x (“YES” to S104), communication (a “session”) is established with the external apparatus (S105). Note that when no external apparatus is found (such as when the power of other external apparatuses is turned off) (“NO” to S104), the operation of the MFP 100 is terminated in the present embodiment (S106). A message showing that there is no external apparatus from which the control program modules can be downloaded may also be displayed.

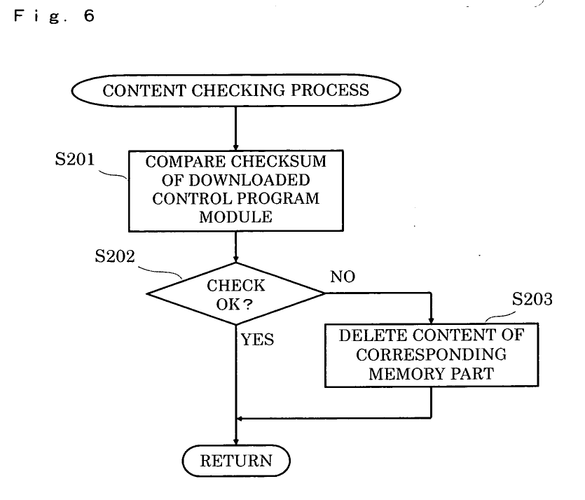

After a session has been established with an appropriate external apparatus, a download request that designates the file name of the necessary control program module is sent to the external apparatus (S107). At this stage, the file name of the control program module to be downloaded is stored in advance in the nonvolatile memory 122. Here, since the necessary control program module can be downloaded except in an aberrational situation, the downloaded control program module is stored in the volatile memory 140 (S108). Note that after storing, a content check as to whether the module has been properly downloaded is carried out (S109). FIG. 6 is a flowchart showing an example of the procedure of the content checking process.

In the content checking process, it is determined whether the module has been properly downloaded by comparing a checksum of the downloaded control program module (S201). If the check result is OK (“YES” to step S202), the processing returns to the procedure shown in FIG. 5. If the check result is not OK, the part of the volatile memory 140 used to store the downloaded module is deleted and the processing returns to the procedure shown in FIG. 5 (S203).

After returning to the flowchart of FIG. 5, when the downloading of the control program modules necessary when the power is turned on is completed (“YES” to S110), the processing is terminated. When the downloading is not completed (including the case where the result of comparing the checksum is that a module has not been properly downloaded), the downloading of the necessary control program modules is requested again (“NO” to S110).

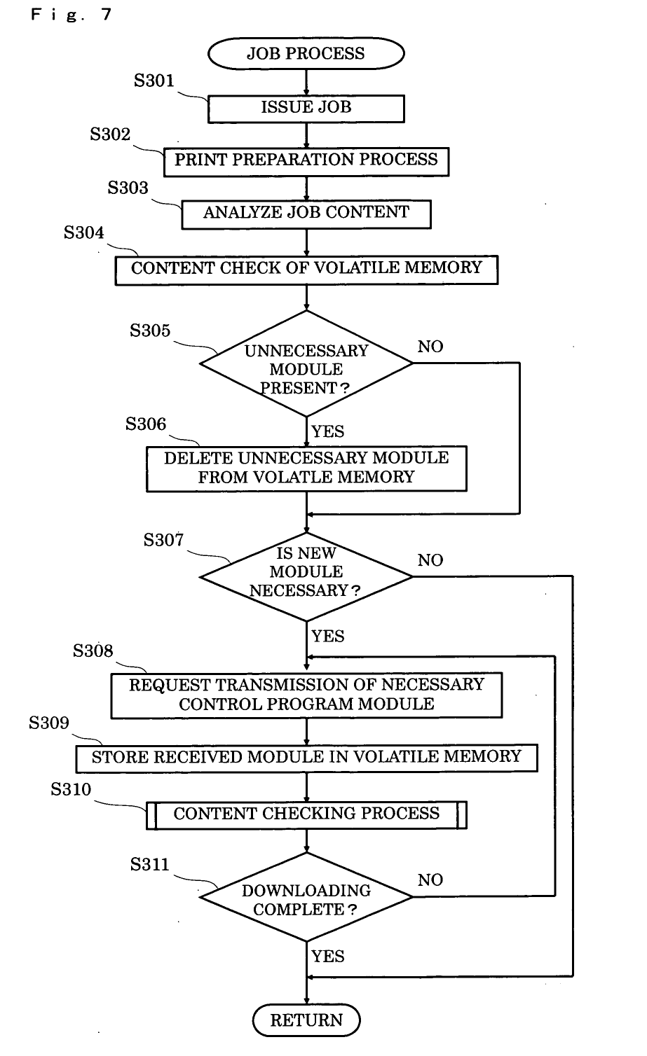

By downloading the control program modules necessary when the power is turned on as described above, it becomes possible to issue a job from the operation panel (not shown) of the MFP 100 or an external apparatus such as the PC 31x. Next, the procedure when a job is issued for the MFP 100 according to the present embodiment will be described. FIG. 7 is a flowchart for explaining one example of the procedure in such case, and is an example where a print job has been issued.

When a print job is issued (S301), a print preparation process for making the MFP 100 capable of executing the print job is carried out (S302). The print preparation process is carried out as necessary, and as examples may stabilize a laser for forming a latent image and heat up a fixing device, but is not limited to such operations.

After this, the job analyzing unit 123 analyzes the job and determines which modules of the control program are necessary for executing the job (S303). The necessary modules differ according to the content of the job. For example, when two-sided printing is designated, a control program module for two-sided printing is necessary, while when an A3-sized recording sheet is designated, a control program module for printing at A3 size is necessary. On the other hand, when B5 size is designated, the control program module for printing at A3 size is not necessary, and when single-sided printing is designated, the control program module for two-sided printing is not necessary.

The MFP 100 according to the present embodiment analyzes the content of the job in this way, and downloads the necessary control program modules and deletes unnecessary control program modules as appropriate, thereby improving the efficiency with which the program memory is used. That is, after it has become clear which modules are necessary, the content of the volatile memory 140 is checked (S304) and it is determined whether unnecessary modules are present inside the volatile memory 140 (S305). Such determination can be made by referring to the management table, an example of which is shown in FIG. 3.

When unnecessary modules are present inside the volatile memory 140 (“YES” to S305), the unnecessary modules are deleted from the volatile memory 140 (S306). Next, when a module that is not stored in the volatile memory 140 has become necessary (“YES” to S307), a request to download the necessary module is sent to an external apparatus such as the PC 31x(S308), and the downloaded module is stored in the volatile memory 140 (S309). Here, the decision as to which region inside the volatile memory 140 should be used to store the downloaded module can be made as appropriate from the free space in the volatile memory 140 and the size of the downloaded module. In the present embodiment, it is assumed that single modules are stored in the volatile memory 140 without being divided.

In the same way as when the power is turned on, a check is carried out using a checksum (S310) and when the downloading of the modules that have become necessary is completed (“YES” to S311), it becomes possible to execute a print job. Other jobs such as copy, scan, FAX transmission jobs are the same as print jobs, so that the issued job is analyzed, unnecessary modules are deleted, and the necessary modules are downloaded, thereby making it possible to use the volatile memory 140 efficiently.

Next, a process that detects the state of the MFP 100 aside from when a job has been issued and deletes unnecessary modules will be described. Aside from modules that can be determined to be necessary or unnecessary by analyzing the content of the issued job, the modules of the control program include modules that can be determined to be necessary or unnecessary based on various states for the MFP 100, such as when a sheet cassette is not attached and when no appliance is connected to a connection port provided on the MFP 100. In the present embodiment, by detecting various static states of the MFP 100 and deleting unnecessary control program modules from the volatile memory 140, the memory is used even more efficiently.

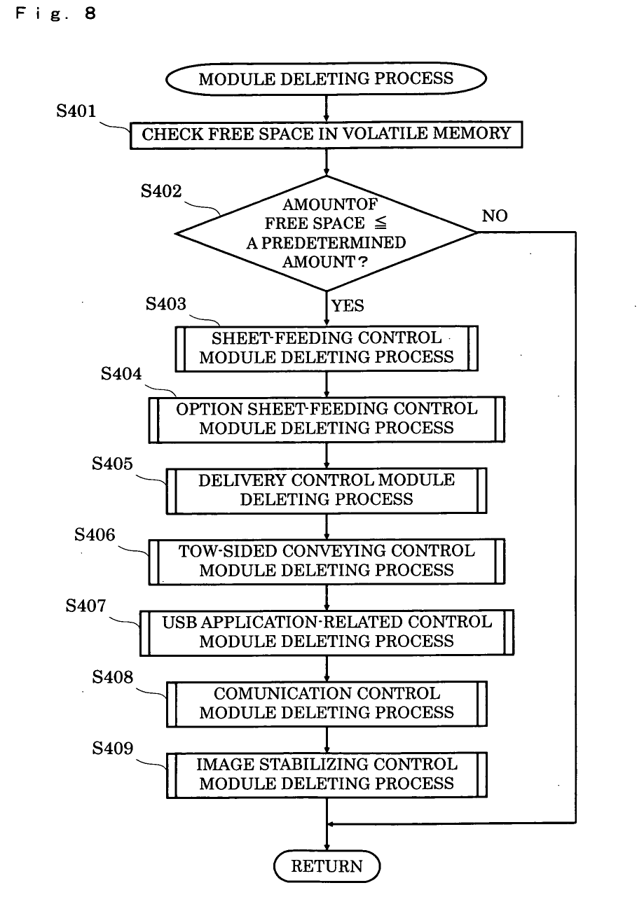

FIG. 8 is a flowchart for explaining one example of the procedure when carrying out a module deleting process in response to the states described above. The processing shown in FIG. 8 can be carried out periodically, or can be carried out according to an indication from the user. In the present embodiment, at the start of the module deleting process, the size of the region storing control program modules in the volatile memory 140 is checked (S401), and when the amount of free space is equal to or below a predetermined amount (“YES” to S402), the processing described below is carried out. This is because when the module deleting process is carried out by the mechanical control CPU 130, the time spent executing the module deleting process shown in FIG. 8 should preferably be minimized.

Note that although 50% of the capacity of the volatile memory 140 may be used for example as the predetermined amount in step S402, the present invention is not limited to such and another amount or percentage can be used. In particular, when a region in the volatile memory 140 in which control program modules is not stored is used to store image data, even if a large storage region is reserved for image data, this may not result in more efficient processing. Accordingly, the predetermined amount may be variable and can be determined according to the functions of the MFP 100, the attachment state of appliances used as options, the capacity of the volatile memory 140, and the like.

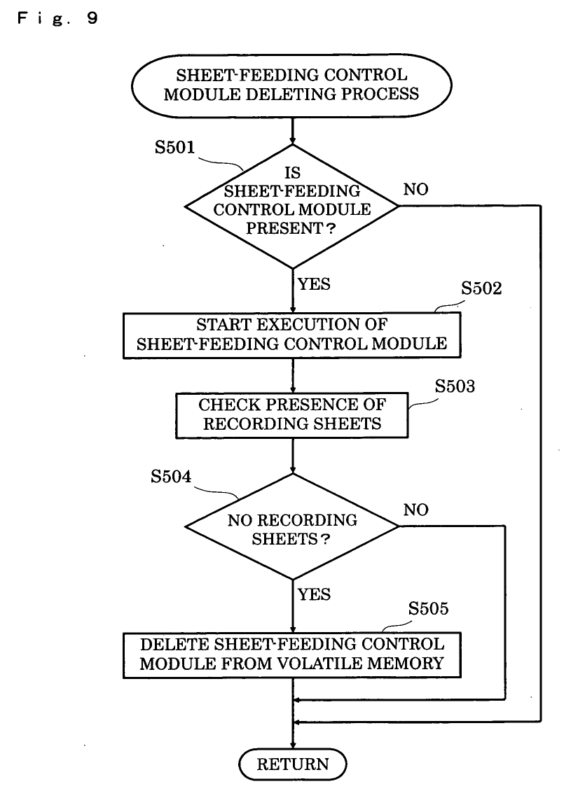

In the present embodiment, first, a deleting process is carried out for a sheet-feeding control module (S403). FIG. 9 is a flowchart showing one example of the procedure of the sheet-feeding control module deleting process. The sheet-feeding control module realizes one or a plurality of sheet-feeding means provided to feed recording sheets for image formation, and in the present embodiment, to determine whether it is necessary to store such module in the volatile memory 140, it is detected whether any recording sheets are stored in a sheet-feeding cassette.

In the sheet-feeding control module deleting process, first it is determined whether the sheet-feeding control module is stored in the volatile memory 140 (S501), and when the sheet-feeding control module is present (“YES” to S501), execution of the sheet-feeding control module is started (S502). This is because in the present embodiment, the processing executed by the sheet-feeding control module includes a determination of whether any recording sheets are present in the sheet-feeding cassette corresponding to a sheet-feeding control module. Accordingly, the sheet-feeding control module does not necessarily have to be executed and a different module may detect whether a recording sheet is present. This is also the case for the other control module deleting processes described later.

When the presence of recording sheets has been checked (S503) and it is detected that there are no recording sheets (“YES” to S504), the sheet-feeding control module is deleted from the volatile memory 140 (S505). This deleting process includes deletion from the volatile memory 140 and deletion from the management table. Note that when the sheet-feeding cassette has been replenished with recording sheets and a job that uses such recording sheets has been issued, the sheet-feeding control module is downloaded again.

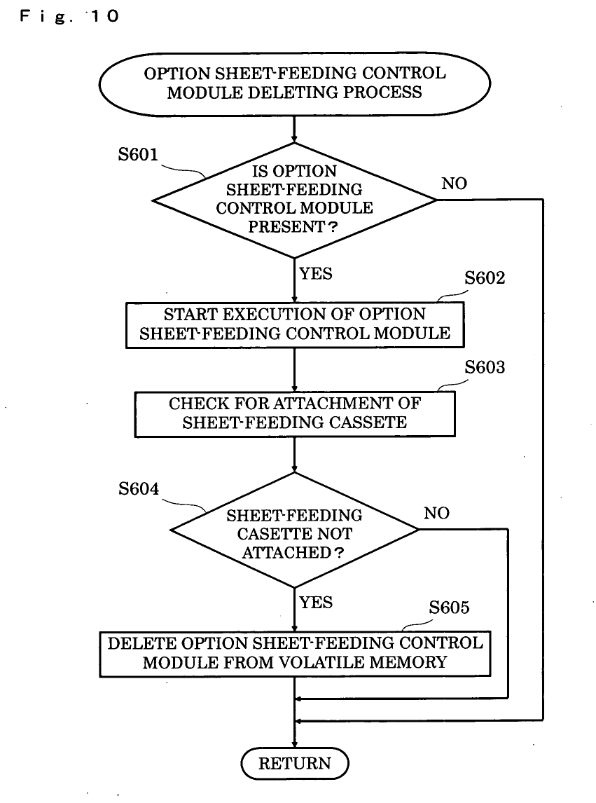

The processing returns to the procedure shown in FIG. 8 and next a deleting process is carried out for an option sheet-feeding control module (S404). FIG. 10 is a flowchart showing one example of the procedure of an option sheet-feeding control module deleting process. The option sheet-feeding control module realizes, in a case where one or more storage cases in which recording sheets are stored can be detachably attached, a sheet-feeding means for supplying recording sheets stored in such storage cases for image formation. In the present embodiment, to determine whether it is necessary to store such module in the volatile memory 140, it is detected whether a storage case corresponding to the option sheet-feeding control module is attached.

In the option sheet-feeding control module deleting process, first it is determined whether the option sheet-feeding control module is present in the volatile memory 140 (S601), and when the option sheet-feeding control module is present (“YES” to S601), execution of the option sheet-feeding control module is started (S602). This is because in the present embodiment, the processing executed by the option sheet-feeding control module includes a determination of whether a corresponding storage case is present.

When the attachment of a storage case is checked (S603) and it is detected that the storage case is not attached (“YES” to S604), the option sheet-feeding control module is deleted from the volatile memory 140 (S605). Note that when the storage case is attached again and a job that uses recording sheets inside the storage case is issued, the option sheet-feeding control module is downloaded again.

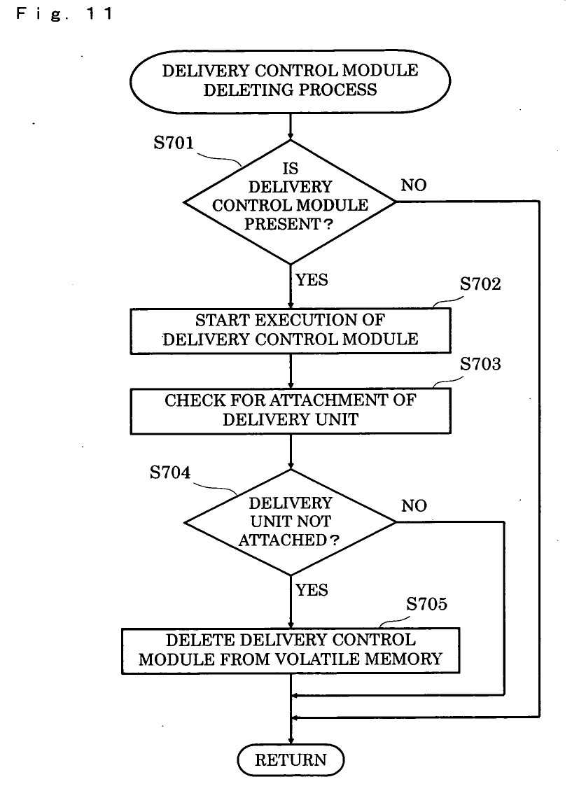

The processing returns to the procedure shown in FIG. 8 and a deleting process for a delivery control module is carried out next (S405). FIG. 11 is a flowchart showing one example of the procedure of the delivery control module deleting process. The delivery control module realizes, in a case where the MFP 100 is equipped with a detachable delivery unit to which a recording sheet on which an image has been formed is delivered, a delivery means that controls a delivery process to the delivery unit when the delivery unit is attached. In the present embodiment, to determine whether it is necessary to store such module in the volatile memory 140, it is detected whether the delivery unit is attached.

In the delivery control module deleting process, it is first determined whether the delivery control module is present in the volatile memory 140 (S701). When the module is present (“YES” to S701), execution of the delivery control module is started (S702). It is then checked whether the delivery unit is attached (S703), and when a state where the delivery unit is not attached is detected (“YES” to S704), the delivery control module is deleted from the volatile memory 140 (S705). Note that when the delivery unit is reattached and a job that uses the delivery unit is issued, the delivery control module is downloaded again.

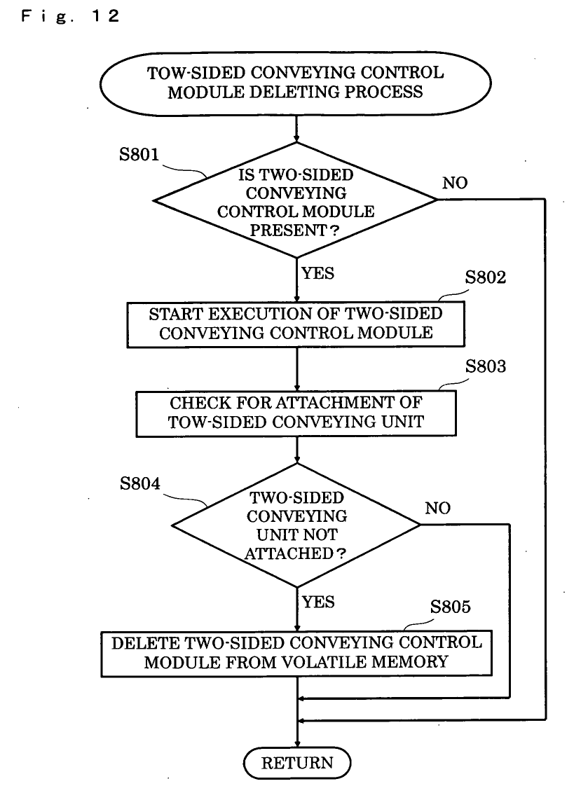

The processing returns to the procedure shown in FIG. 8 and a deleting process for a two-sided conveying control module is carried out next (S406). FIG. 12 is a flowchart showing one example of the procedure of the two-sided conveying control module deleting process. The two-sided conveying control module realizes, in a case where the MFP 100 is equipped with a detachable two-sided printing unit for conveying a recording sheet that has had an image formed on one side thereof back to the image forming unit, a two-sided printing means that carries out two-sided printing by controlling the two-sided printing unit and the image forming unit when the two-sided printing unit is attached. In the present embodiment, to determine whether it is necessary to store such module in the volatile memory 140, it is detected whether the two-sided printing unit is attached.

In the two-sided conveying control module deleting process, it is first determined whether the two-sided conveying control module is present in the volatile memory 140 (S801). When the module is present (“YES” to S801), execution of the two-sided conveying control module is started (S802). It is then checked whether the two-sided printing unit is attached (S803), and when a state where the two-sided printing unit is not attached is detected (“YES” to S804), the two-sided conveying control module is deleted from the volatile memory 140 (S805). Note that when the two-sided printing unit is reattached and a job that uses the two-sided printing unit is issued, the two-sided conveying control module is downloaded again.

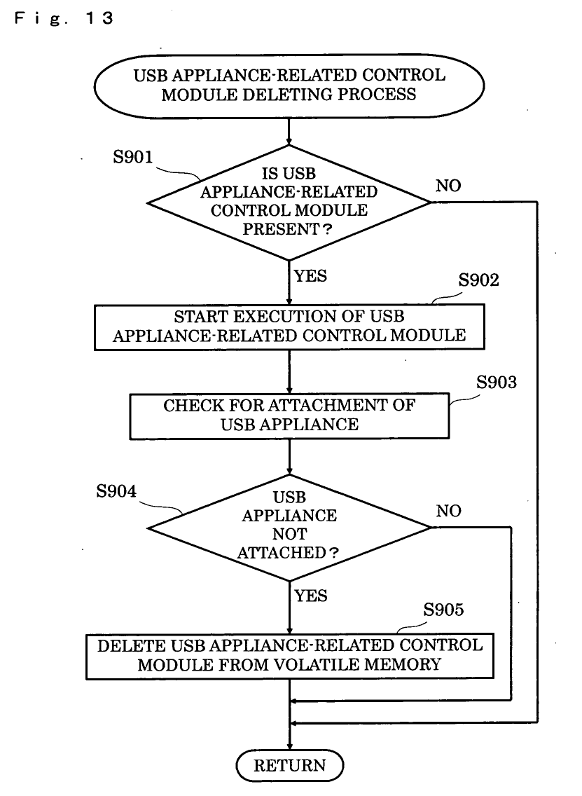

The processing returns to the procedure shown in FIG. 8 and a deleting process for a USB appliance-related control module is carried out next (S407). FIG. 13 is a flowchart showing one example of the procedure of the USB appliance-related control module deleting process. The USB appliance-related control module realizes, in a case where an image processing apparatus such as the MFP 100 is equipped with a USB port, communication via the USB port. To determine whether it is necessary to store such module in the volatile memory 140, in the present embodiment, it is detected whether an appliance is connected to the USB port provided on the MFP 100.

In the USB appliance-related control module deleting process, it is first determined whether the USB appliance-related control module is present in the volatile memory 140 (S901). When the module is present (“YES” to S901), execution of the USB appliance-related control module is started (S902). It is then checked whether a USB appliance is connected (S903), and when a state where no USB appliance is connected is detected (“YES” to S904), the USB appliance-related control module is deleted from the volatile memory 140 (S905). When a plurality of USB ports are provided, the module is deleted when no USB appliances are attached to any of the USB ports. Note that when a USB appliance is reattached, as one example the USB appliance-related control module may be downloaded again when a job that uses the appliance connected to the USB port is issued.

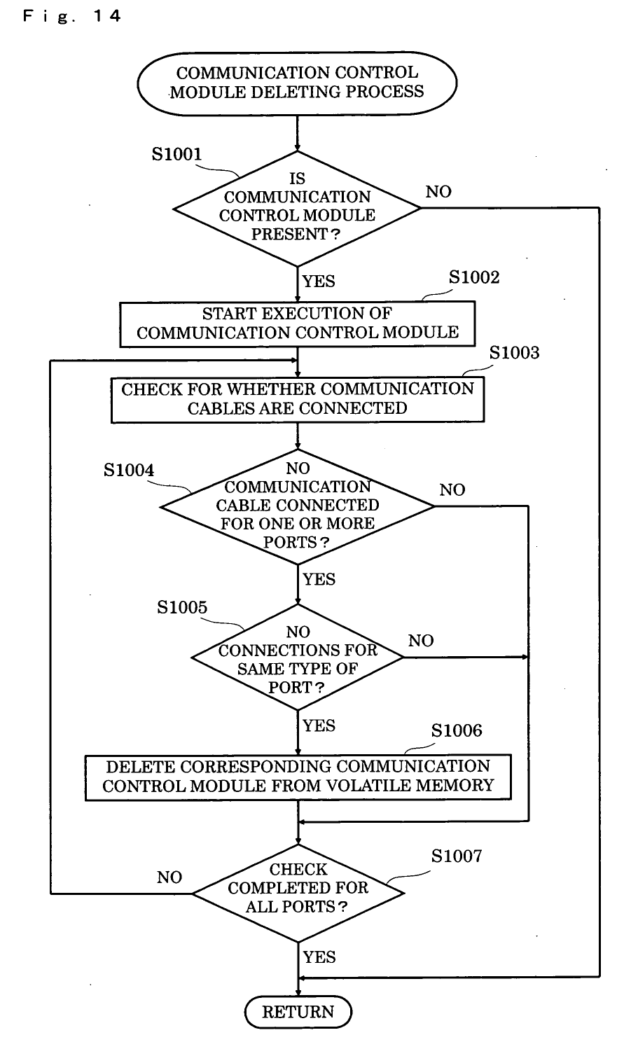

The processing returns to the procedure shown in FIG. 8 and a deleting process for a communication control module is carried out next (S408). FIG. 14 is a flowchart showing one example of the procedure of the communication control module deleting process. The communication control module realizes communication via various communication ports provided on an image processing apparatus such as the MFP 100. To determine whether it is necessary to store such module in the volatile memory 140, in the present embodiment, it is detected whether communication cables are attached to the various ports provided on the MFP 100.

In the communication control module deleting process, it is first determined whether the communication control module is present in the volatile memory 140 (S1001). When the module is present (“YES” to S1001), execution of the communication control module is started (S1002). It is then checked whether communication cables are connected to the ports (S1003), and when a state where no communication cable is connected is detected for one or more ports (“ES” to S1004) and no ports of the same type are connected (“YES” to S1005), the communication control module for that type of port is deleted from the volatile memory 140 (S1006). In many cases, a plurality of ports are provided for connecting communication cables, and when all of such ports have been checked (“YES” to S1007), the communication control module deleting process is terminated.

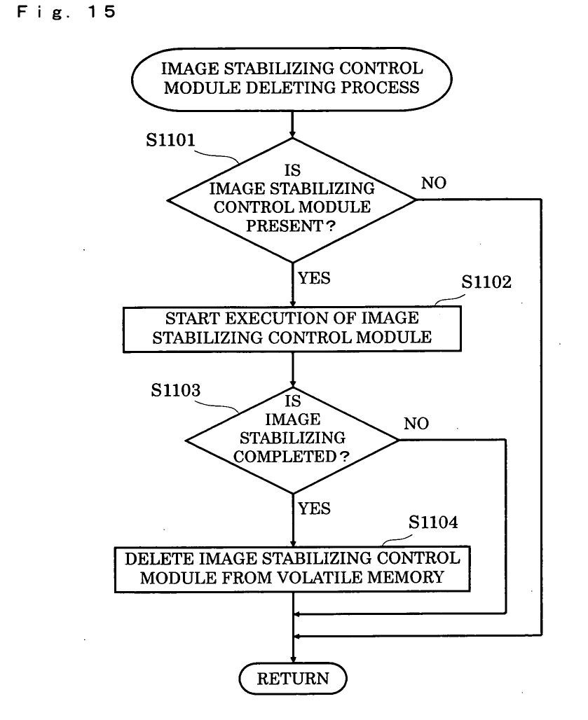

The processing returns to the procedure shown in FIG. 8 and a deleting process for an image stabilizing control module is carried out next (S409). FIG. 15 is a flowchart showing one example of the procedure of the image stabilizing control module deleting process. The image stabilizing control module realizes AIDC (Automatic Image Density Control), for example. In the present embodiment, the image stabilizing control module is deleted when the processing shown in FIG. 8 is executed.

In the image stabilizing control module deleting process, it is first determined whether the image stabilizing control module is present in the volatile memory 140 (S1101). When the module is present (“YES” to S1101), execution of the image stabilizing control module is started (S1102). That is, an image stabilizing process is executed. When the image stabilizing process is completed (“YES” to S1103), the image stabilizing control module is deleted from the volatile memory 140 (S1104). Note that when it is necessary to execute the image stabilizing process again, the image stabilizing control module is downloaded again.

The steps of the module deleting process described above (steps S403 to S409) do not all need to be carried out every time, and only certain steps may be executed depending on the functions of the MFP 100 and the like. The execution order of the steps may also be changed as appropriate.

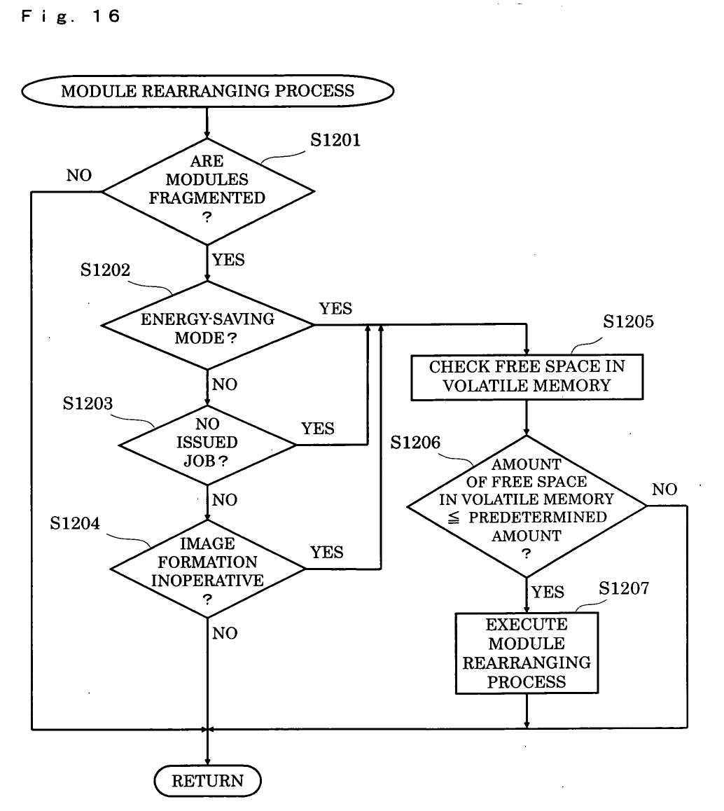

Next, a rearranging process for the modules in the volatile memory 140 will be described. FIG. 16 is a flowchart useful in explaining one example of the procedure of the module rearranging process. With the present module rearranging process, it is determined whether rearranging is necessary and whether it is suitable to carry out rearranging at the present time before the module rearranging process is carried out. In the example in FIG. 16, it is first determined whether fragmentation has occurred for the modules in the volatile memory 140 (S1201). When fragmentation has not occurred (“NO” to S1201), the rearranging process is terminated at that point.

In steps S1202 to S1204, it is determined whether the rearranging process should be executed at the present time. Such determination regarding the execution timing is made since the rearranging process should preferably be carried out when the load of the MFP 100 is as small as possible. In the example in FIG. 16, the rearranging process is carried out when the MFP 100 is in energy-saving mode (S1202), when no job has been issued (S1203), and when an image formation operation is not possible (S1204).

It can be detected whether the MFP 100 is in energy-saving mode using a notification from the energy saving mode control unit 124. Similarly, it can be detected whether a job has been issued by inquiring to the main CPU 120. As one example, jobs that have been issued but have not been executed and/or a job being executed can be managed using a job management table inside a volatile memory (not shown in FIG. 2) connected to the main CPU 120, and by referring to such table, it is possible to detect the presence of a job being executed and/or a job about to be executed.

An image formation inoperative state is managed by the main CPU 120 that receives an output from the inoperative state detecting unit 160, and therefore can be detected by inquiring to the main CPU 120. Here, the image formation inoperative state can include a state where a sheet feeding cassette is empty, a state where consumables such as a toner cartridge is not attached, a state where consumables such as a toner cartridge or a photosensitive drum have reached the end of their operating lives, and a state where a paper jam has occurred. Such states can be detected by sensors provided at appropriate parts as in the conventional art, with the inoperative state detecting unit 160 receiving outputs of the respective sensors to detect the inoperative state.

When any of steps S1202 to S1204 is applicable, the size of the part in the volatile memory 140 where the control program is not stored is checked (S1205), and when the size of such part (the “remaining part”) is a predetermined amount or less (“YES” to S1206), the module rearranging process is carried out (S1207). The predetermined amount in step S1206 can be set in advance according to the functions of the MFP 100, the intended use of the free space of the volatile memory 140, and other conditions. The determination in step S1206 may be made based on the size of the free space or the ratio of free space.

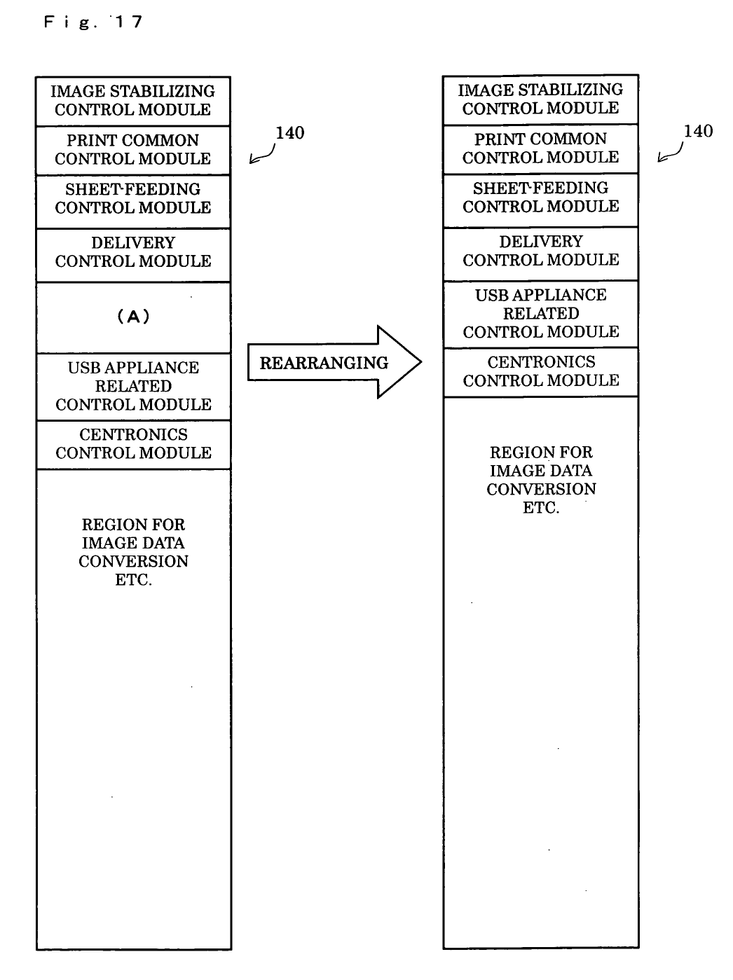

FIG. 17 is a diagram useful in explaining the fragmentation of modules and the module rearranging process. On the left side of FIG. 17, as one example the option sheet-feeding cassette control module that was previously downloaded and stored in the region shown by the symbol (A) is deleted as unnecessary for a job that has been issued and the region (A) becomes empty, resulting in fragmentation.

Although, the empty region shown by the symbol (A) can be used as a region for converting image data or the like, doing so can cause a drop in processing efficiency. For this reason, at the timing described above, the control program deleting/rearranging unit 132 changes the arrangement of the modules. By carrying out the rearranging process, the free space (space that is used for converting image data and the like in the present embodiment) in the volatile memory 140 can be made continuous, thereby raising the processing efficiency.

Modifications

Although an embodiment of the present invention has been described above, it should be obvious that the present invention is not limited to the specific example described in the above embodiment. Several example modifications are described below.

(1) Although the modules are managed in FIG. 4 and the like based on the processing contents of the modules in the above embodiment, the processing contents of the modules are not limited to the examples given above and when a plurality of CPUs are provided as in the above embodiment, modules including modules that run on any of the CPUs can be freely managed. Also, so long as it is possible to determine whether modules can be deleted from a volatile memory based on an issued job or the state of an apparatus, for example, the present invention can be applied regardless of the composition of the modules.

(2) Although the case where control program modules are downloaded from an external apparatus such as the PC 31A via the network 500 has been described in the above embodiment, acquisition of a new control program module can be carried out via a memory card such as a COMPACT FLASH (registered trademark) card or smart media card, a USB memory, or various kinds of disc medium such as an MO, a CD, or a DVD. With this construction also, a control program module that carries out a process that acquires the control program from such media should preferably be stored in a nonvolatile memory.

(3) It is also possible to use a construction where the main CPU 120 (a first processor), the mechanical control CPU 130 (a second processor), and the volatile memory 140 are arranged on the same semiconductor chip. When SOC (System On a Chip) techniques are used, the construction of the present invention can be favorably used to reduce the capacity of the program memory arranged on the same chip as the processor.

(4) A variety of other methods can be used to determine which control program modules are deletable (such as whether a paper jam has occurred for a scanner or an input error has occurred for a FAX transmission number). There are also cases where modules should not be deleted if the corresponding situation can be easily remedied. Accordingly, it is also possible to determine whether a control program can be deleted when a state such as a lack of recording sheets has continued for a predetermined period.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An image processing apparatus comprising:
a control program acquiring unit that acquires a control program for controlling the image processing apparatus in module units from outside the image processing apparatus;
a volatile memory device that stores at least one of the modules acquired by the control program acquiring unit;
a module deletion determining unit that determines which modules out of the at least one modules stored in the volatile memory device are deletable; and
a deletion controller that deletes the modules determined to be deletable by the module deletion determining unit from the volatile memory device.

2. The image processing apparatus according to claim 1,
wherein a part of the volatile memory device that does not store the control program is used as a region that stores image data which is a target or a result of processing.

3. The image processing apparatus according to claim 1, further comprising:
a first processor that executes processing that acquires modules from the outside; and
a second processor that executes the modules stored in the volatile memory device.

4. The image processing apparatus according to claim 3,
wherein the first processor, the second processor, and the volatile memory device are arranged on the same semiconductor chip.

5. The image processing apparatus according to claim 1, further comprising:
a job analyzing unit that analyzes a job issued to the image processing apparatus; and
a necessary module determining unit that determines which modules are necessary for executing the job based on analysis by the job analyzing unit.

6. The image processing apparatus according to claim 5,
wherein the module deletion determining unit determines, based on the analysis by the job analyzing unit, that modules that are unnecessary for executing the job are deletable.

7. The image processing apparatus according to claim 5,
wherein the control program acquiring unit acquires the modules determined by the necessary module determining unit to be necessary for executing the job.

8. The image processing apparatus according to claim 1,
wherein the module deletion determining unit includes a detector that detects a state of the image processing apparatus, and
based on the detected state of the image processing apparatus, the module deletion determining unit detects whether a module corresponding to the state is deletable.

9. The image processing apparatus according to claim 8, further comprising:
an image forming unit that forms an image on a recording sheet; and
a sheet feeding unit that supplies the recording sheet to the image forming unit,
wherein the detector detects an empty state of the sheet feeding unit and the module deletion determining unit is operable when the empty state has been detected, to determine that a module that realizes the sheet feeding unit that is empty is deletable.

10. The image processing apparatus according to claim 8, further comprising:
an image forming unit that forms an image on a recording sheet; and
a sheet feeding unit including at least one storage case that stores a recording sheet and is detachable, the sheet feeding unit supplying the recording sheet stored in one of the at least one storage case to the image forming unit,
wherein the detector detects whether the at least one storage case is attached and the module deletion determining unit is operable when a state where the at least one storage case is not attached has been detected, to determine that a module that realizes the sheet feeding unit corresponding to the unattached at least one storage case is deletable.

11. The image processing apparatus according to claim 8, further comprising:
an image forming unit that forms an image on a recording sheet; and
a delivery controller that includes a delivery unit that delivers the recording sheet on which the image has been formed by the image forming unit and is detachably attached to the image processing apparatus, and is operable when the delivery unit is attached to control a delivery process to the delivery unit,
wherein the detector detects whether the delivery unit is attached and the module deletion determining unit is operable when a state where the delivery unit is not attached has been detected, to determine that a module that realizes the delivery controller is deletable.

12. The image processing apparatus according to claim 8, further comprising:
an image forming unit that forms an image on a recording sheet; and
a two-sided controller including a two-sided printing unit that conveys the recording sheet on which the image has been formed by the image forming unit back to the image forming unit and is detachably attached to the image processing apparatus, the two-sided controller being operable when the two-sided printing unit is attached to carry out two-sided printing by controlling the two-sided printing unit and the image forming unit,
wherein the detector detects whether the two-sided printing unit is attached and the module deletion determining unit is operable when a state where the two-sided printing unit is not attached has been detected, to determine that a module that realizes the two-sided printing unit is deletable.

13. The image processing apparatus according to claim 8,
wherein the detector detects, for each connection port for external appliances provided on the image processing apparatus, whether an external appliance is connected via the connection port,
and the module deletion determining unit determines, by detecting whether appliances are connected via the connection terminals, that modules aside from modules that are necessary for connecting to external appliances are deletable.

14. The image processing apparatus according to claim 1,
wherein the deletion controller is operable when a total size of one or more regions of the volatile memory device in which the control program is stored is not more than a predetermined size, to not delete the modules determined to be deletable.

15. The image processing apparatus according to claim 1, further comprising
a module rearrangement controller that rearranges the control program in the volatile memory device so that a region of the volatile memory device in which the control program is not stored is continuous.

16. The image processing apparatus according to claim 15,
wherein the module rearrangement controller includes a rearrangement execution determining unit that determines whether to carry out rearranging.

17. The image processing apparatus according to claim 16,
wherein the rearrangement execution determining unit is operable when no job has been issued to determine to carry out rearranging.

18. The image processing apparatus according to claim 16,
wherein the rearrangement execution determining unit is operable when the image processing apparatus is in energy-saving mode or is about to enter the energy-saving mode, to determine to carry out rearranging.

19. The image processing apparatus according to claim 16, further comprising
an image forming unit that forms an image on a recording sheet,
wherein the rearrangement execution determining unit is operable when the image forming unit is in an image formation inoperative state, to determine to carry out rearranging.

20. The image processing apparatus according to claim 15,
wherein the module rearrangement controller is operable when a total size of one or more regions in the volatile memory device in which the control program is stored is not more than a predetermined size, to determine to not carry out rearranging.

21. An image processing system comprising:
an image processing apparatus; and
a control program providing apparatus that includes a storage device and is connected to the image processing apparatus,
the image processing apparatus including:
a control program acquiring unit that acquires a control program for controlling the image processing apparatus in module units from the control program providing apparatus;
a volatile memory device that stores at least one of the modules acquired by the control program acquiring unit;
a module deletion determining unit that determines which modules out of the at least one modules stored in the volatile memory device are deletable; and
a deletion controller that deletes the modules determined to be deletable by the module deletion determining unit from the volatile memory device.

22. The image processing system according to claim 21,
wherein the image processing apparatus further includes:
a job analyzing unit that analyzes a job issued to the image processing apparatus; and
a necessary module determining unit that determines which modules are necessary for executing the job based on analysis by the job analyzing unit.

23. The image processing system according to claim 22,
wherein the module deletion determining unit determines, based on the analysis by the job analyzing unit, that modules that are unnecessary for executing the job are deletable.

24. The image processing system according to claim 22,
wherein the control program acquiring unit acquires the modules determined by the necessary module determining unit to be necessary for executing the job from the control program providing apparatus.
